(19) United States
(12) Patent Application Publication
(10) Pub. No.: US 2018/0040066 A1
(43) Pub. Date: Feb. 8, 2018

(54) INTERACTIVE PLATFORM FOR THE EXCHANGE OF COMMODITIZED PRODUCTS

(71) Applicant: Amadeus S.A.S., Biot (FR)

(72) Inventor: Umit Cholak, Woodstock, GA (US)

(21) Appl. No.: 15/227,041

(22) Filed: Aug. 3, 2016

(51) Int. Cl. G06Q 40/04; G06Q 10/08

(52) U.S. Cl. CPC G06Q 40/04; G06Q 10/087

(57) ABSTRACT

Methods, systems, and computer program products for a product exchange system that allows end users, providers, and retailers to buy and sell commoditized products. The product exchange system is in communication with at least one inventory system and a plurality of client devices. The product exchange system includes a data module for receiving an indicator from the inventory system. The indicator is an indication of availability for a specific product, and is associated with a predetermined set of parameters that includes a resource amount associated with the product. The product exchange system also includes an availability module receiving the indicator from the data module. The availability module makes the product available upon request. The product exchange system also includes a request module receiving a plurality of client requests from the client devices. The client requests are each associated with a resource value.

### TECHNICAL FIELD

The invention generally relates to computers and computer software, and in particular to methods, systems, and computer program products for a product exchange system that allows end users, providers, and retailers to buy and sell commoditized products.

### BACKGROUND

Computer technology is increasingly used in the travel industry to manage, support, book, reserve, and process travel reservations as well as data associated therewith. For example, a travel information provider may allow for third party reservation agents (i.e., travel agents) or travelers to request flight availability data and associated pricing by accessing an airline's inventory and pricing system. Reservation agents and travelers may then purchase tickets based on the prices set by a particular airline. However, this approach forces travelers to purchase tickets at a price that is unilaterally determined by the airline itself. Furthermore, it should also be appreciated that pricing inefficiencies exist with this approach, since an airline may not be able to changes its pricing quickly enough to reflect various changes in the market that may affect ticket prices.

Reservation agents and travelers may also purchase tickets through a discount provider's website. Specifically, a traveler may make an offer to buy a particular travel reservation having certain desired characteristics such as date and location, at a defined price. The discount provider may then attempt to locate a travel product that matches the desired characteristics, which includes a price that is equal to or less than the defined price determined by the traveler. However, if the discount provider is unable to locate a travel product having these attributes, then the discount provider may inform the traveler that no travel products that satisfy his or her requirements exist.

It is to be appreciated that reservation agents and travelers typically submit multiple queries to an airline's inventory system before actually purchasing a particular travel reservation. As online booking activity increases, the look-to-book ratio, which is the number of seat availability request messages received for every sell transaction, also increases significantly. The increased activity may place additional demands upon a travel reservation system, since each query is received and processed separately. The look-to-book ratio may be very large in some instances, and is constantly growing. For example, for some airlines the look-to-book ratio may be as high as 450,000:1. Indeed, the look-to-book ratio is an ever-growing volume that may actually cause the travel reservation system to sometime provide inaccurate availability and pricing. Specifically, the information for a travel reservation system may be obtained from a cache-based inventory system, which stores previously computed availability answers. Sometimes this data is outdated and may not reflect the current availability status or price of a particular flight. For example, a flight may appear to be sold out, when in fact there are still seats available for sale. Similarly, it may also appear as though there are remaining seats on a flight event though in reality, the flight is actually sold out.

In addition to the above mentioned issues, sometimes there may be a number of unsold seats on a particular flight. These unsold seats result in a loss of revenue for the airline. Furthermore, some flights are in very high demand, which results in these particular flights being sold out well in advance of their respective departure dates. As a result, some individuals may be unable to purchase tickets for some high demand flights a few days before these flights depart. It is to be appreciated that sometimes these individuals are willing to pay a very high price for a last-minute ticket for one of these high demand flights. In fact, some of these individuals are willing to pay a significantly higher price for a ticket than the price paid by the travelers who have already purchased their tickets. However, since the flight is already sold out the airline is unable to accommodate these individuals, thereby resulting in a loss of revenue for the airline. It is to be appreciated that both of the above-mentioned scenarios occur due to the inherent characteristics of the current revenue management systems in the market. Furthermore, revenue management optimization logic relies on demand forecasting. Good demand forecasting is recognized as being unbiased and of low volatility. However, regardless of the quality of the demand forecasting, half the time the demand forecasting is below the actual demand and the other half of the time it is above the actual demand. As a result, airlines may sometimes sell too many or too few seats for a given flight.

Thus, improved methods, systems, and computer program products for the sale of travel related products are needed that decrease the number of data transactions and also increase the efficiency of processing data by computer-based devices.

### SUMMARY

In an embodiment of the invention, a product exchange system in communication with at least one inventory system and a plurality of client devices is provided. The product exchange system includes a data module for receiving an indicator from the at least one inventory system. The indicator is an indication of availability for a specific product, and is associated with a resource amount for the product. The product exchange system also includes an availability module receiving the indicator from the data module. The availability module makes the product available upon request. The product exchange system also includes a request module receiving a plurality of client requests from the client devices. The client requests are each associated with a resource value. The request module sorts the client requests based on the resource values, and identifies a top client request associated with the resource value having the highest value when compared to a remaining number of the client requests. The product exchange system also includes a match module that receives both the top client request and the indicator, and compares the top client request with the indicator. The match module associates the top client request and the indicator together in response to the resource value of the top client request being at least equal to the resource amount associated with the indicator.

In one embodiment, the product exchange system further includes a plurality of inventory systems. The data module receives a specific indicator from each of the inventory systems. The availability module receives the specific indicators from the data module. In one embodiment, the availability module sorts the specific indicators based on a predetermined set of parameters. The predetermined set of parameters include timing, routing, an origin and a destination, a departure date, and class associated with the product.

In one embodiment, the request module receives the specific indicators from the availability module. The request module sorts the specific indicators by their respective resource amount. In one embodiment, the request module identifies a lowest indicator associated with the resource amount having the lowest value when compared to a remaining number of the specific indicators. In one embodiment, the match module receives both the top client request and the lowest indicator from the request module and compares the top client request with the lowest indicator. The match module associates the top client request and the lowest indicator together in response to the top client request being at least equal to the lowest indicator.

In one embodiment, the product exchange system further comprises a display module. The display module receives both the top client request and the indicator and publishes both the top client request and the indicator for display to at least one of the client devices. In one embodiment, the display module removes both the top client request and the indicator from display in response to the top client request being at least equal to the resource amount associated with the indicator.

In one embodiment, in response to the top client request being less than the resource amount associated with the indicator, another indicator is re-submitted by the at least one inventory system. In another embodiment, in response to the top client request being less than the resource amount associated with the indicator, another client request is re-submitted from one of the client devices.

In another embodiment of the invention, a method of exchanging a product by a product exchange system in communication with at least one inventory system and a plurality of client devices is provided. The method includes receiving an indicator from the an inventory system by a computer. The indicator is an indication of availability for the product, and is associated with a resource amount for the product. The method also includes receiving a plurality of client requests from the client devices by the computer. The client requests are each associated with a resource value. The method also includes sorting the client requests based on the resource values. The method also includes identifying a top client request associated with the resource value having the highest value when compared to a remaining number of the client requests. The method also includes comparing the top client request with the indicator. Finally, the method includes associating the top client request and the indicator together in response to the resource value of the top client request being at least equal to the resource amount associated with the indicator.

In another embodiment of the invention, a computer program product is provided for exchanging a product by a product exchange system in communication with an inventory system and a plurality of client devices. The computer program product comprises a non-transitory computer-readable storage medium and program code stored on the non-transitory computer-readable storage medium that, when executed by one or more processors, causes the one or more processors to receive an indicator from the at least one inventory system by a computer. The indicator is an indication of availability for the product, and the indicator is associated with a resource amount for the product. The one or more processors receive a plurality of client requests from the client devices by the computer. The client requests are each associated with a resource value. The one or more processors may sort the client requests based on the resource values. The one or more processors may identify a top client request associated with the resource value having the highest value when compared to a remaining number of the client requests. The one or more processors may compare the top client request with the indicator. The one or more processors may associate the top client request and the indicator together in response to the resource value of the top client request being at least equal to the resource amount associated with the indicator.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a product exchange platform for the exchange of products via a network.

FIG. 2 is a diagrammatic view of an exemplary computer system of FIG. 1.

FIG. 3 is a diagrammatic view of the product exchange platform of FIG. 1, where the product exchange platform is in communication with a plurality of client devices and a plurality of inventory systems.

FIG. 4 is an illustration of an exemplary travel board generated by the product exchange platform shown in FIG. 3, where the travel board considers a plurality of asking prices generated by various airlines and a plurality of bidding prices generated by various end users.

FIG. 5 is an illustration of the exemplary travel board generated shown in FIG. 4, where Airline 3 has lowered its asking price and a match has been made between the lowered asked price submitted by Airline 3 and Traveler 1.

FIG. 6 is an illustration of the exemplary travel board generated shown in FIG. 4, where Traveler 3 has increased his or her bid price, and a match is made between the increased bid price submitted by Traveler 3 and Airline 1.

FIG. 7 is a graph illustrating an exemplary price curve for a particular travel product.

### DETAILED DESCRIPTION

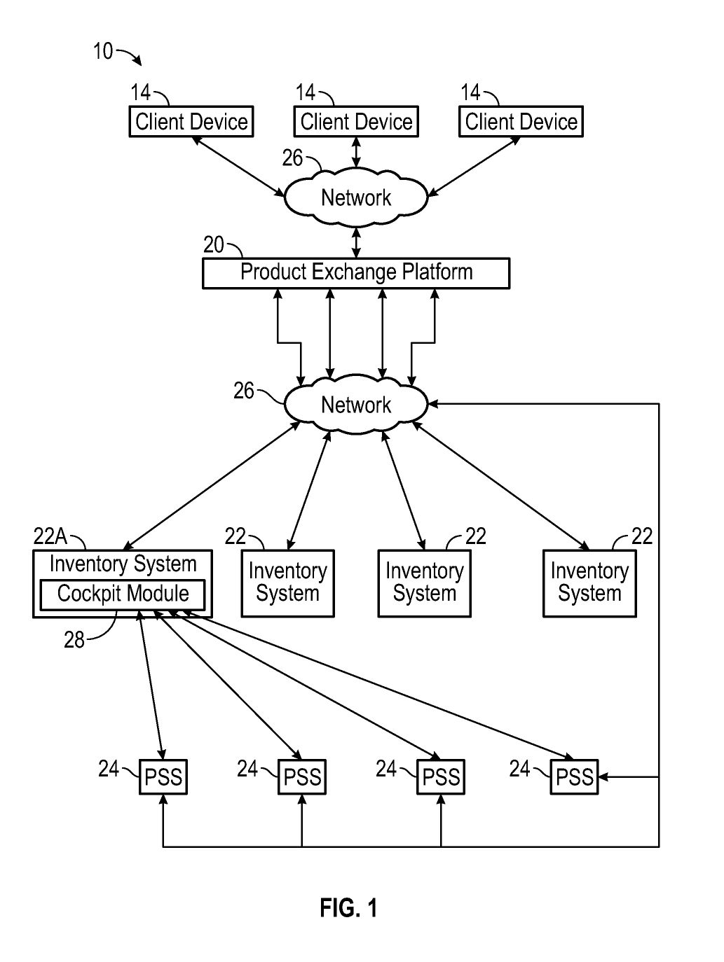

Referring now to FIG. 1, an operating environment 10 in accordance with an embodiment of the invention may include one or more client devices 14, an inventory or product exchange platform 20, a plurality of inventory systems 22, and a plurality of passenger servicing systems (PSS) 24. Each of the client devices 14, the product exchange platform 20, the inventory systems 22, and the PSSs 24 may communicate through a network 26. The network 26 may include one or more private or public networks (e.g., the Internet) that enable the exchange of data.

The client devices 14 may each comprise a desktop computer, laptop computer, tablet computer, smart phone, or any other suitable computing device. In one embodiment, an end user such as, for example, a traveler, may use a respective client device 14 to search, bid, and book travel products by accessing the product exchange platform 20 though the network 26. For example, the end user may launch a browser application, and use the browser application to bid on available travel products on a website provided by the product exchange platform 20. Furthermore, the traveler may book a selected travel product by entering payment information into the website.

As explained in greater detail below, the product exchange platform 20 enables end users to view asking prices for a specific product such as, for example, a travel product. The asking price may represent a resource amount or price at which a travel provider is willing to sell the specific product. The product exchange platform 20 also allows for end users to submit a client request, which is associated with a bid price. The bid price represents a resource value or price at which the end user is willing to pay for the specific product. Furthermore, as also explained in greater detail below, the product exchange platform 20 may also enable travel providers associated with the inventory systems 22 to adapt their asking prices based on the bid prices submitted by the end users. Similarly, the end users may also adapt their bid prices based on the asking prices submitted by the travel providers.

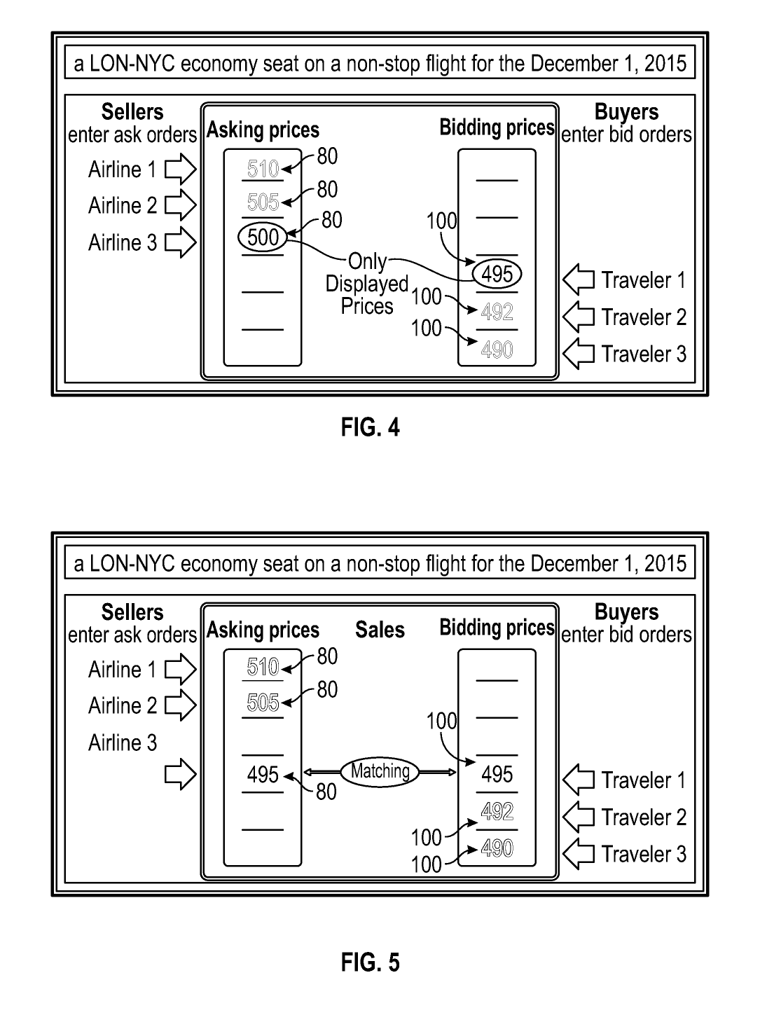

In one embodiment, the product may be any type of travel-related inventory such as, for example, airline travel, train travel, hotel rooms, car rentals, sightseeing, and other travel-related activities. For example, in the non-limiting embodiments as shown in FIGS. 4-6 and described below, the product is an airline ticket. Specifically, in the below described embodiments the airline ticket is non-stop flight New York City to London, economy class, for Dec. 1, 2015. Although travel products are described in the disclosed embodiments, it is to be appreciated that the product exchange platform 20 is not limited to travel related products. Instead, the product exchange platform 20 may be used to consummate the sale of a perishable product having a pre-defined expiration date as well. A perishable product is a product unavailable after its expiration or a departure date. For example, in the context of airline travel, the perishable product is an airline seat and the departure date is the day which the flight departs. In the context of ticketing time limit (TTL), the expiration date is the end of a date and time that a ticket needs to be issued for a reservation to avoid cancellation of the booking and/or expiration of the fare quote. The perishable product may be any type of inventory item unavailable after its departure or expiration date. Furthermore, it should also be appreciated that non-perishable products may also be purchased as well such as, for example, internet access on a flight, meals, and gifts.

The product exchange platform 20 may also generate and update passenger name records (PNRs) for the end users purchasing travel products. Each PNR may include information relating to the travel product (such as a travel itinerary for one or more airline passengers), fares or fees used to price the travel product, and a form of payment (FOP) element that indicates the specific form of payment, such as credit card information, that was used to make the purchase. The product exchange platform 20 may also send an updated PNR back to a respective PSS 24. It is to be appreciated that when the product exchange platform 20 may update the PNR may depend upon the nature of the product. For example, if the product is transferable, there is no reason to update the PNR immediately. In contrast, nontransferable tickets are communicated and updated immediately.

The inventory systems 22 may each correspond to a respective travel provider. A respective travel provider may be, for example, one or more airlines, an online travel agency (OTA), a travel agency, or an end user. As explained in greater detail below, in one approach an end user such as a traveler who has already booked a travel product may re-sell his or her travel product using the product exchange platform 20 if the product is defined as transferable by the original content provider. Each inventory system 22 may determine availability and pricing for travel products for a corresponding travel provider. For example, in the context of air travel, the inventory systems 22 may define how many seats are available on a particular flight or in a particular market by opening and closing individual booking classes. Those of ordinary skill in the art will readily appreciate that an available unit of inventory in the inventory system may not necessarily correspond to a specific physical seat on an aircraft. This is because the available inventory may exceed the number of physical seats in a market to allow for overbooking.

The PSSs 24 may be a set of systems used by a travel provider. For example, if the travel provider is an airline, then the PSS 24 may include an airline reservation system (RES), an airline inventory system (INV) and a departure control system (DCS). In the exemplary embodiment as shown in FIG. 1, there are four PSSs 24, which each represent a unique airline. Each PSS 24 may be in communication with a cockpit module 28 of a specific one of the inventory systems 22A. The cockpit module 28 of the inventory system 22A may act as a monitoring interface that identifies inventory for sale on the product exchange platform 20, recommends the asking price or resource amount at which a travel provider is willing to sell the specific travel product, pushes selected travel products or inventory to the product exchange platform 20, and monitors the product exchange platform 20 for changes in the bid prices submitted by the end users.

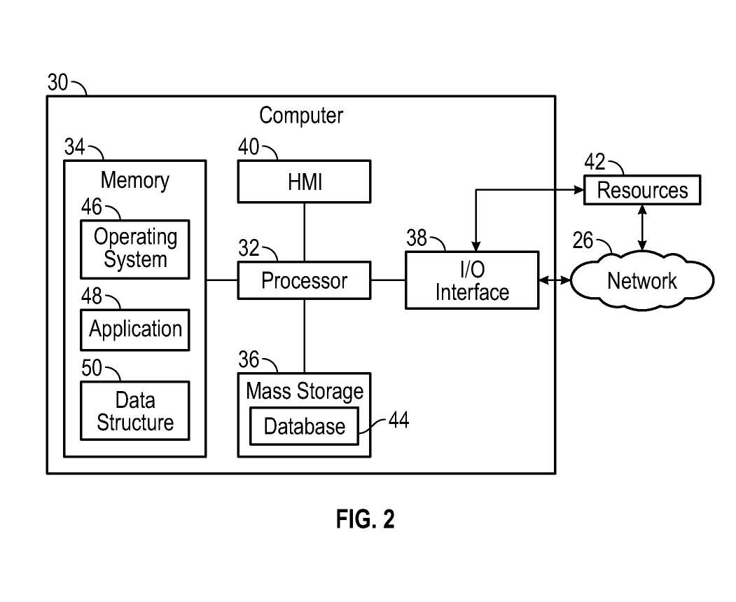

Referring now to FIG. 2, client devices 14, the product exchange platform 20, the inventory systems 22, and the PSSs 24 of operating environment 10 may be implemented on one or more computer devices or systems, such as exemplary computer system 30. The computer system 30 may include a processor 32, a memory 34, a mass storage memory device 36, an input/output (I/O) interface 38, and a Human Machine Interface (HMI) 40. The computer system 30 may also be operatively coupled to one or more external resources 42 via the network 26 or I/O interface 38. External resources may include, but are not limited to, servers, databases, mass storage devices, peripheral devices, cloud-based network services, or any other suitable computer resource that may be used by the computer system 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, volatile or non-volatile solid state device, or any other device capable of storing information.

The processor 32 may operate under the control of an operating system 46 that resides in memory 34. The operating system 46 may manage computer resources so that computer program code embodied as one or more computer software applications, such as an application 48 residing in memory 34, may have instructions executed by the processor 32. In an alternative embodiment, the processor 32 may execute the application 48 directly, in which case the operating system 46 may be omitted. One or more data structures 50 may also reside in memory 34, and may be used by the processor 32, operating system 46, or application 48 to store or manipulate data.

The I/O interface 38 may provide a machine interface that operatively couples the processor 32 to other devices and systems, such as the network 26 or external resource 42. The application 48 may thereby work cooperatively with the network 26 or external resource 42 by communicating via the I/O interface 38 to provide the various features, functions, applications, processes, or modules comprising embodiments of the invention. The application 48 may also have program code that is executed by one or more external resources 42, or otherwise rely on functions or signals provided by other system or network components external to the computer system 30. Indeed, given the nearly endless hardware and software configurations possible, persons having ordinary skill in the art will understand that embodiments of the invention may include applications that are located externally to the computer system 30, distributed among multiple computers or other external resources 42, or provided by computing resources (hardware and software) that are provided as a service over the network 26, such as a cloud computing service.

The HMI 40 may be operatively coupled to the processor 32 of computer system 30 in a known manner to allow a user to interact directly with the computer system 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 44 may reside on the mass storage memory device 36, and may be used to collect and organize data used by the various systems and modules described herein. The database 44 may include data and supporting data structures that store and organize the data. In particular, the database 44 may be arranged with any database organization or structure including, but not limited to, a relational database, object database, a hierarchical database, a network database, or combinations thereof. A database management system in the form of a computer software application executing as instructions on the processor 32 may be used to access the information or data stored in records of the database 44 in response to a query, where a query may be dynamically determined and executed by the operating system 46, other applications 48, or one or more modules.

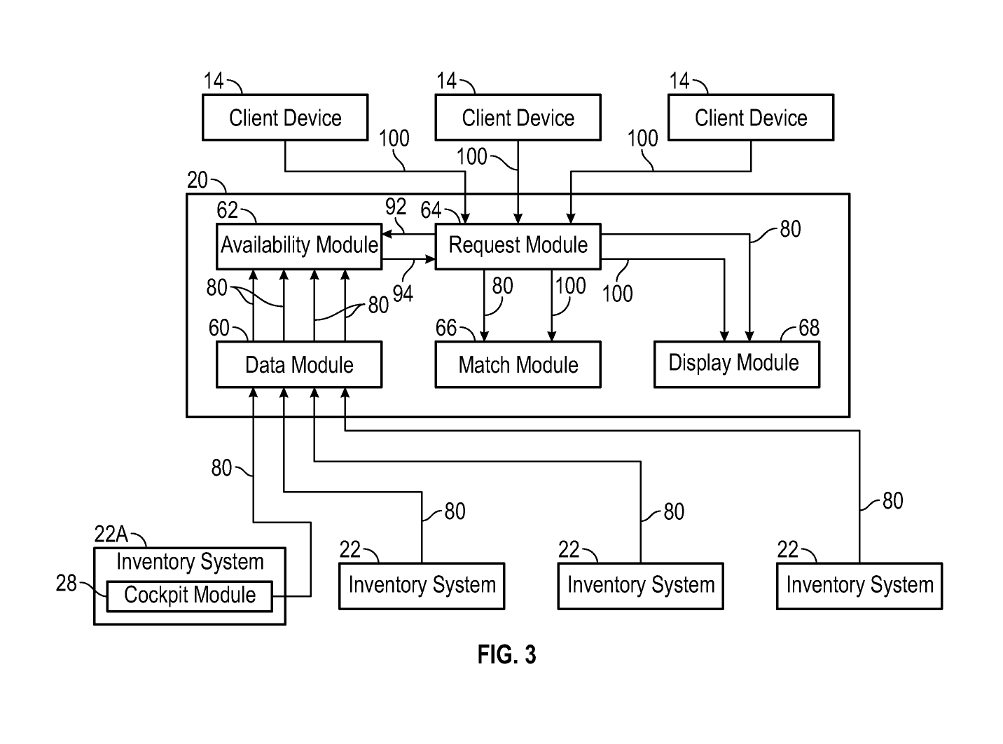

Turning now to FIG. 3, in an exemplary embodiment of the disclosure the product exchange platform 20 may include a data module 60, an availability module 62, a request module 64, a match module 66, and a display module 68. The modules 60, 62, 64, 66 and 68 are shown as distinct components, which may indicate the use of modular programming techniques. However, the software design may decrease the extent to which the modules 60, 62, 64, 66 and 68 are distinct by combining at least some program functions of multiple modules into a single module. Moreover, those of ordinary skill in the art will readily understand that the functions attributed to the modules 60, 62, 64, 66 and 68 may be distributed in other ways, or on other systems than those depicted. Thus, embodiments of the invention are not limited to the specific arrangement of systems or modules shown in FIG. 3.

As seen in FIG. 3, the inventory systems 22 may each push at least one indicator 80 to the data module 60 of the product exchange platform 20. In particular, the cockpit module 28 of the inventory system 22A may push one or more indicators 80 to the product exchange platform 20. The indicators 80 represent a specific product available from a specific travel provider. For example, in the context of air travel, each indicator represents a particular airline ticket that a travel provider is willing to sell at a specific asking price. Although each inventory system 22 is illustrated as pushing a corresponding indicator 80, it is to be appreciated that only a portion of the inventory systems 22 may be pushing an indictor 80 as well.

It should also be appreciated that the inventory systems 22 may push the indicators 80 to the product exchange platform 20 prior to the product exchange platform 20 receiving bid prices from the end users via the client devices 14. That is, the inventory systems 22 may push the indicators 80 proactively, without the need for the product exchange platform 20 to send any kind of notification first to the inventory systems 22. Inventory systems that are currently available typically receive multiple requests for checking the availability for a particular travel product. In response to receiving a particular request, the inventory system may then check to determine availability, and then sends an indication of availability back to the requestor. In contrast, the disclosed approach of pushing availability indicators 80 to the product exchange platform 20 results in a 1-to-1 transaction that reduces overall traffic.

The data module 60 of the product exchange platform 20 may receive the indicators 80 from the inventory systems 22. Each indicator 80 may include a predetermined set of parameters. The predetermined set of parameters include the asking price associated with a specific travel product. The predefined set of parameters may also include various characteristics that are unique to the specific travel product such as, for example, time frame, routing (i.e., if a flight or journey is non-stop or includes multiple stops), origin and destination, departure date or dates, and class (e.g., first, business, and economy). It is to be appreciated that these are simply examples of the attributes that may be associated with a specific product. Furthermore, it should also be appreciated that the predetermined set of parameters needs to be categorized carefully in order to make sure that similar products are categorized in the same manner. For example, a flight departing at 9 am and a flight departing at 9:30 am would be categorized as the same type of flight. However, if the time window becomes too wide, then the products may differentiate too much from one another. In other words, the time windows needs to be small enough to consider similar times, but at the same time wide enough to consider all relevant flights.

The data module 60 may send the indicators 80 to the availability module 62. The availability module 62 may then sort the indicators 80 based on the predetermined set of parameters. Specifically, in one embodiment the indicators 80 may first be organized by date as well as the time of day. The times are generally organized by a range of times and not an exact point in time. For example, the date and times may be arranged by morning travel (e.g., times from about 7 am to 12 pm) for a particular day, afternoon travel (e.g., between about 12 pm to about 5 pm), and evening travel (e.g., from about 5 pm to about 10 pm). It is to be appreciated that these windows of travel time may vary depending on the particular market. The indicators 80 may also be organized by origin and destination, class (e.g., first, business, and economy), and by routing (i.e., non-stop or includes multiple stops).

It is to be appreciated that the indicators 80 are sorted without regard to the travel provider or source. For example, in the context of air travel, the indicators 80 are sorted without regard to the particular airline carrier. This means that the travel products are presented as commodities to end users. In other words, the travel products presented by the product exchange platform 20 are interchangeable with one another so long as they meet a specific requirement. Some examples of the requirements include, but are not limited to, the specific date of travel, the departure time frame, origin and destination, class, and routing. This means that the travel products are commoditized by the product exchange platform 20. Thus, end users may purchase travel products without regard to the particular source or provider of the travel product.

In addition to the particular travel provider, the indicators 80 may also be sorted by the availability module 62 without regard to any restrictions associated with the travel product. Some examples of restrictions in the context of air travel include, but are not limited to, advanced reservations/ticketing, minimum/maximum stay requirements, and blackout dates.

FIG. 4 is an illustration of an exemplary travel board or platform that may be generated by the product exchange platform 20, which is displayed upon an HMI of the client devices 14 as well as the computing devices associated with the inventory systems 22. Referring now to both FIGS. 3 and 4, the request module 64 may receive one or more client requests 100 for the specific travel product from via the client devices 14. The client requests 100 are associated with a corresponding bid price, which represents the price a traveler is willing to pay for the specific travel product. For example, in the embodiment as described, there are three client requests 100 for a non-stop flight from New York City to London, economy class, for Dec. 1, 2015. The first request 100 is associated with a bid price of $495 from Traveler 1, the second request 100 is associated with a bid price of $492 from Traveler 2, and the third bid price 100 is associated with a bid price of $490 from Traveler 3.

In response to receiving at least one client request 100 from one of the client devices 14, the request module 64 may send a request 92 to the availability module 62. The request 92 is a request to the availability module 62 to provide all of the available indictors 80 for the specific travel product that corresponds to the client request 100. For example, in the embodiment as shown in FIGS. 3 and 4, the request 92 is a request for all the indictors 80 for an airline ticket for a non-stop flight New York City to London, economy class, for Dec. 1, 2015. If there is more than one client request 100 submitted for the specific travel product, then the request module 64 may sort or arrange the client requests 100 in descending order of bid price. For example, in the embodiment as described the client requests are arranged in descending order of bid price from $495, $492, and $490. The request module 64 may then identify the client request 100 associated with the highest bid price. For example, in the embodiment as described, the highest bid price is $495.

In response to receiving the request 92, the availability module 62 may first determine if there are any available indicators 80 for the specific travel product. For example, in the non-limiting embodiment as described, the availability module 62 may search for airline tickets for a non-stop flight from New York City to London, economy class, for Dec. 1, 2015. If the availability module 62 is able to locate at least one indicator 80 for the specific travel product, then the availability module 62 may send an answer 94 to the request module 64. The answer 94 may include all of the indicators 80 that the availability module 62 located.

In response to receiving the answer 94 from the availability module 62, the request module 64 may sort the indicators 80 based on the asking prices. Specifically, the availability module 62 may sort or arrange the indicators 80 in descending order of price. For example, in one embodiment there are three indicators 80 for a non-stop flight New York City to London, economy class, for Dec. 1, 2015 priced at $510 from Airline 1, $505 from Airline 2, and $500 from Airline 3. Thus, the indicators 80 are arranged in descending order of asking price, $510, $505, and $500. The availability module 62 may also identify the indicator 80 associated with the lowest price. For example, in the embodiment as described, the indicator 80 associated with the lowest price is $500.

The request module 64 may then send the indictor 80 associated with the lowest price (e.g., $500) as well as the client request 100 associated with the highest bid price (e.g., $495) to the match module 66 as well as the display module 68. As seen in FIG. 4, the display module 68 only displays the indicator 80 associated with the lowest price and the client request 100 associated with the highest bid price upon the travel board. That is, only the lowest asking price of $500 and the highest bid price of $495 may be visible to the end users. It is to be appreciated that the difference between the lowest asking price and the highest bid price may be referred to as the spread. Furthermore, the price of the very last transaction may be referred to as the market price. In one embodiment, an end user may send a query to the product exchange platform 20 to inquire about the market price of a particular product (e.g., the amount paid for the last non-stop flight New York City to London, economy class, on Dec. 1, 2015). Thus, end users may quickly and easily be able to find out the market price for a particular product, which is not currently possible. Instead, end users have to visit numerous online travel sites to determine the market price.

The match module 66 may determine if the client request 100 associated with the highest bid price is equal to or exceeds the indicator 80 associated with the lowest asking price. In the event that the highest bid price is equal to or exceeds the indicator 80 associated with the lowest asking price, both the highest bid price and the lowest asking price are linked together by the match module 66, and are then removed from the travel board by the display module 68. The match module 66 may then consummate a sale. Specifically, the end user associated with the greatest bid price may be charged for the specific travel reservation, and the funds collected from the end user may be transferred to the travel provider associated with the lowest asking price. However, in the event the highest bid price is not at least equal to the indicator associated with the lowest asking price, then no sale is consummated. For example, in the embodiment as shown in FIG. 4, because the bid price of $495 is less than the asking price of $500, no sale is consummated.

As seen in FIG. 4, it is to be appreciated that the indicators 80 are listed without regard to the travel provider or any travel restrictions. In other words, the travel products have been commoditized such that end user make purchasing decisions without considering the source (e.g., the airline) of the travel products. It should also be appreciated that the end users are anonymous, and are only viewable based on a particular bid price. Products sold using the product exchange platform 20 may be airline specific where the content provider is known or opaque, where the content provider is unknown.

Further, a product sold using the product exchange platform 20 can be an opaque product, where some aspects of the product are provided for bidding as unknown to client devices 14. In various embodiments, the opacity of the travel product, or the aspects made unknown, can be for example, on the travel provider (e.g. the airline), the travel date of the product, the travel times, the outbound time, the inbound time, the travel duration, the origin and/or destination, the number of stops, and/or the number of seats still available. In an embodiment, the product exchange platform 20 provides a client an option to reveal an opaque aspect in the opaque product for a predetermined price. The options for revealing opaque aspects may be differently priced, for example by the perceived significance as to transparency.

In one embodiment, the above-mentioned approach may be used by travel providers to only sell a relatively small amount of their total inventory. Specifically, for example, some airline carriers may only sell their ancillary inventory using product exchange platform 20. Some other types of travel providers, such as travel agents, may purchase travel products at wholesale prices, and may then use the product exchange platform 20 to sell individual travel products to various end users. As explained in greater detail below, the travel providers may have an opportunity to adapt their asking prices if the current highest bid price is not at least equal to the lowest indicator 80. Similarly, the end users are also provided with the opportunity to adapt their bid prices if the current highest bid price is not at least equal to the lowest indicator 80.

It is to be appreciated that once the product exchange platform 20 determines if the client request 100 associated with the highest bid price is equal to or exceeds the indicator 80 associated with the lowest asking price, the travel providers may resubmit more indicators 80, and the end users may also resubmit client requests 100. Traveler providers and end users may also resubmit indicators 80 and client requests 100 once the product change platform 20 has compared the highest bid price with the lowest asking price, and has determined that no match exists. For example, FIG. 5 is an illustration of the travel board that may be displayed in response to the highest bid price of $495 being less than the lowest asking price of $500, which was described above and shown in FIG. 4.

Referring to both FIGS. 3 and 5, since no sale was consummated, Airline 3 decreases its asking price of its indicator 80 to $495. Therefore the highest bid price is now equal to the indicator 80 associated with the lowest asking price. Thus, the indicator 80 associated with the lowest asking price of $495 is sent to both the match module 66 and the display module 68. Then, both the highest bid price and the lowest asking price are linked together and removed from the travel board, and the match module 66 may consummate a sale.

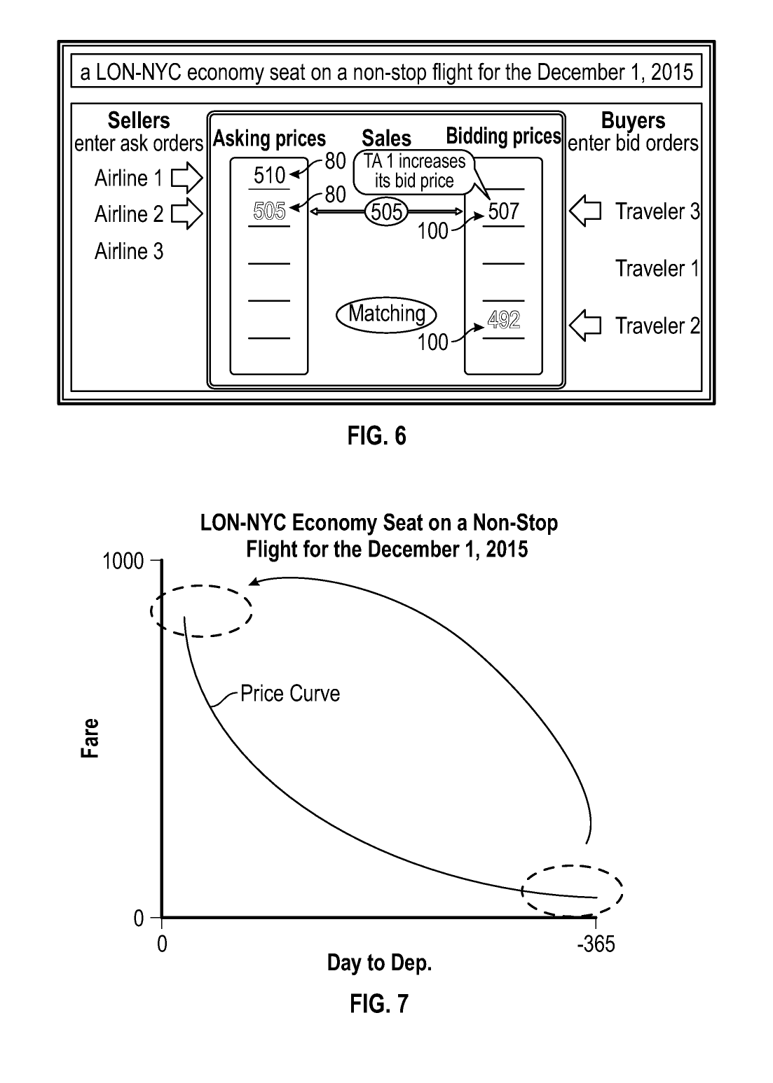

FIG. 6 is an illustration of the travel board in response to the highest bid price of $500 being equal to the lowest asking price of $500. As seen in FIG. 6, both the highest bid price and the lowest asking price have been removed from the travel board. Moreover, Traveler 3 has increased his or her asking price to $507. Thus, as seen in FIG. 6, the client request 100 associated with the highest bid price ($507) is now greater than the remaining indicator 80 associated with the lowest asking price ($500). Thus, both the highest bid price and the lowest asking price are linked together and removed from the travel board, and the match module 66 may consummate a sale.

It is to be appreciated that the above-described product exchange platform 20 illustrated in FIG. 3 allows for both travel providers to adapt their prices dynamically, based on demand. Those of ordinary skill in the art will readily appreciate that travelers to currently purchase travel products at a price that is unilaterally determined by the travel provider itself. However, sometimes a travel provider may not be able to change its asking prices quickly enough to reflect various changes in the market that may affect demand and pricing. The above-mentioned approach solves these pricing inefficiencies by allowing travel providers to dynamically adjust their asking prices based on the bid prices submitted by one or more end users.

In addition to the above-mentioned advantages, the disclosed product exchange platform 20 may also provide various features for travel providers to offer travel products that are callable or refundable for a specific price, which are described in greater detail below. It is to be appreciated that the inventory systems 22 push indicators 80 to the product exchange platform 20, where the indicators 80 represent travel products that each offer a futures contact. For example, a forward contract is a contract between two parties to buy and sell an asset at a specified time in the future for at a price that is agreed upon in the present. A traditional airline ticket is an example of a forward contract. In contrast, a futures contract is a special form of a forward contract, which includes standardized characteristics. Specifically, futures contracts detail the quality and quantity of the underlying product, and are standardized to facilitate trading on an exchange. It is to be appreciated that tickets sold using the product exchange platform 20 are a type of futures contract. Indeed, regardless of which airline provides the ticket, from a buyer's perspective the product, which is an airline ticket, remains the same.

In one embodiment, the inventory system 22 may push indicators 80 to the product exchange platform 20, where the indicators 80 may represent travel products that are callable. If a travel product is callable this means that after an end user has submitted a successful bid and a sale is consummated between the travel provider and the end user, the travel provider still has the option to call back or re-purchase the travel product from the end user prior to the expiration date of the travel reservation. For example, if the travel product is an airline ticket for a flight that departs on Dec. 1, 2015, this means that an airline (or other travel provider) has the option of buying back the airline ticket prior to Dec. 1, 2015.

It is to be appreciated that if a travel product is callable, the travel provider typically purchases the travel product back from the end user at a higher price than what the end user originally paid. For example, if an end user submitted a successful bid price of $550 using the product exchange platform 20 to purchase a travel product that is callable, then the travel provider generally may not call back the travel product for a price that is equal to or less than $550.

FIG. 7 is a diagram illustrating an exemplary price curve for a particular travel product. For example, the price curve could represent a flight from New York City to London. The x-axis of the graph represents the days to departure, and the y-axis represents the fare or price at which a travel provider may be able to charge for the particular travel product. As seen in FIG. 7, as the days to departure approach zero, the price at which the travel provider may charge for the flight may increase at an exponential rate.

Those of ordinary skill in the art will readily appreciate that that some types of travel products, such as flights between two large cities such New York City and London, may be in very high demand. As a result, these travel products tend to be sold out well in advance of their expiration date. Indeed, sometimes flights from New York City to London may sell out well in advance of its departure date. If a travel provider determines there is unexpected demand for a particular travel product such as the flight from New York City to London, then the travel provider may utilize the callable feature to buy back some of its travel products. The travel provider may then re-sell the travel product to travelers who are willing to pay a higher price than the successful bid price. For example, if an airline determines that travelers are willing to pay $950 for the airline ticket from New York City to London on Nov. 28, 2015, then the travel provider may call back the ticket that the end user previously purchased for $550 using the product exchange platform 20, albeit at a higher price than what the end user originally paid. However, the travel provider now has the option of selling the ticket to a user at a much higher price than what was originally paid for the ticket, thereby maximizing revenue for the airline.

In yet another embodiment, the inventory system 22 may push indicators 80 to the product exchange platform 20, where the indicators 80 may represent travel products that are refundable or resalable. If a travel product is resalable this means that after an end user has submitted a successful bid and a sale is consummated between the travel provider and the end user, the end user has the option to sell back the travel product to the travel provider prior to the expiration data using the product exchange platform 20. For example, if the travel product is an airline ticket for a flight that departs on Dec. 1, 2015, this means that the end user has the option of selling the airline ticket prior to Dec. 1, 2015. It is to be appreciated that an end user may profit from the sale of the travel product if he or she is able to sell the travel product at a price that is higher than what he or she paid. Similarly, it should also be appreciated that the end user may also lose money from the sale as well if the travel product is unable to be sold at a price that is at least equal to the price that he or she paid for the travel product.

Referring generally to the figures, the disclosed system improves the overall efficiency of processing data associated with the specific travel reservation, and also solves a problem that is rooted in computer technology. Specifically, the above-described product exchange platform 20 allows for both travel providers to adapt their prices dynamically, based on demand. Moreover, it should also be appreciated that the disclosed system also provides an end user with the best available price, which is guaranteed at any time. It is to be appreciated that this feature is difficult, if not impossible, to provide using current travel systems. Indeed, sometimes travelers may believe that they have found the best price available for a particular airline ticket, only to find out that the ticket is not actually available at that price when the time comes to actually purchase the ticket.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow charts, sequence diagrams, and/or block diagrams.

In certain alternative embodiments, the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A product exchange system in communication with at least one inventory system and a plurality of client devices, the product exchange system comprising:
one or more processors;
a data module executed by the one or more processors, the data module configured to receiving an indicator from the at least one inventory system, wherein the indicator is an indication of availability for a product, and the indicator is associated with a resource amount for the product;
an availability module executed by the one or more processors, the availability module configured to receive the indicator from the data module, the availability module making the product available upon request;
a request module executed by the one or more processors, the request module configured to receive a plurality of client requests from the client devices, the client requests each associated with a resource value, wherein the request module sorts the client requests based on their respective resource values and identifies a top client request associated with the resource value having a highest value when compared to a remaining number of the client requests; and
a match module executed by the one or more processors, the match module configured to receive both the top client request and the indicator and configured to compare the top client request with the indicator, wherein the match module associates the top client request and the indicator together in response to the resource value of the top client request being at least equal to the resource amount associated with the indicator.

2. The product exchange system of claim 1 further comprising:
a plurality of inventory systems,
wherein the data module receives a specific indicator from each of the inventory systems, and the availability module receives the specific indicators from the data module.

3. The product exchange system of claim 2 wherein the availability module sorts the specific indicators based on a predetermined set of parameters.

4. The product exchange system of claim 3 wherein the predetermined set of parameters include timing, routing, an origin and a destination, a departure date, and class associated with the product.

5. The product exchange system of claim 2 wherein the request module receives the specific indicators from the availability module, and wherein the request module sorts the specific indicators by their respective resource amount.

6. The product exchange system of claim 5 wherein the request module identifies a lowest indicator associated with the resource amount having a lowest value when compared to a remaining number of the specific indicators.

7. The product exchange system of claim 6 wherein the match module receives both the top client request and the lowest indicator from the request module and compares the top client request with the lowest indicator, and wherein the match module associates the top client request and the lowest indicator together in response to the top client request being at least equal to the lowest indicator.

8. The product exchange system of claim 1 further comprising:
a display module,
wherein the display module receives both the top client request and the indicator and publishes both the top client request and the indicator for display to at least one of the client devices.

9. The product exchange system of claim 8 wherein the display module removes both the top client request and the indicator from display in response to the top client request being at least equal to the resource amount associated with the indicator.

10. The product exchange system of claim 1 wherein, in response to the top client request being less than the resource amount associated with the indicator, another indicator is re-submitted by the at least one inventory system.

11. The product exchange system of claim 1 wherein, in response to the top client request being less than the resource amount associated with the indicator, another client request is re-submitted from one of the client devices.

12. A method of exchanging a product by a product exchange system in communication with at least one inventory system and a plurality of client devices, the method comprising:
receiving an indicator from the at least one inventory system by a computer, wherein the indicator is an indication of availability for the product, and the indicator is associated with a resource amount for the product;
receiving a plurality of client requests from the client devices by the computer, the client requests each associated with a resource value;
sorting the client requests based on the resource values;
identifying a top client request associated with the resource value having a highest value when compared to a remaining number of the client requests;
comparing the top client request with the indicator; and
associating the top client request and the indicator together in response to the resource value of the top client request being at least equal to the resource amount associated with the indicator.

13. The method of claim 12 further comprising:
receiving a specific indicator from each of a plurality of inventory systems.

14. The method of claim 13 further comprising:
sorting the specific indicators based on a predetermined set of parameters; and
sorting the specific indicators by their respective resource amounts.

15. The method of claim 14 wherein the predetermined set of parameters further include timing, routing, an origin and a destination, a departure date, and class associated with the product.

16. The method of claim 14 further comprising:
identifying a lowest indicator associated with the resource amount having a lowest value when compared to a remaining number of the specific indicators.

17. The method of claim 16 further comprising:
comparing the top client request with the lowest indicator; and
associating the top client request and the lowest indicator together in response to the top client request being at least equal to the lowest indicator.

18. The method of claim 12 further comprising:
publishing both the top client request and the indicator for display to at least one of the client devices.

19. The method of claim 12 further comprising:
removing both the top client request and the indicator from display in response to the top client request being at least equal to the resource amount associated with the indicator.

20. A computer program product for exchanging a product by a product exchange system in communication with an inventory system and a plurality of client devices, the computer program product comprising:
a non-transitory computer-readable storage medium; and
program code stored on the non-transitory computer-readable storage medium that, when executed by one or more processors, causes the one or more processors to:
receiving an indicator from the inventory system by a computer, wherein the indicator is an indication of availability for the product, and the indicator is associated with a resource amount for the product;
receiving a plurality of client requests from the client devices by the computer, the client requests each associated with a resource value;
sorting the client requests based on the resource values;
identifying a top client request associated with the resource value having a highest value when compared to a remaining number of the client requests;
comparing the top client request with the indicator; and
associating the top client request and the indicator together in response to the resource value of the top client request being at least equal to the resource amount associated with the indicator.
